(19) United States
(12) Patent Application Publication
(10) Pub. No.: US 2023/0225330 A1
(43) Pub. Date: Jul. 20, 2023

(54) COMPOSITIONS AND METHODS FOR PLANT GROWTH PROMOTION

(71) Applicant: PALEOBIOTICA, INC., SAUSALITO, CA (US)

(72) Inventors: RAUL DE JESUS CANO, SAN LUIS OBISPO, CA (US); JUDITH M. DANIELS, ARVADA, CO (US)

(21) Appl. No.: 17/927,931

(22) PCT Filed: May 28, 2021
(86) PCT No.: PCT/US2021/034825

§ 371 Date: Nov. 28, 2022

Related U.S. Application Data
(60) Provisional application No. 63/031,030, filed on May 28, 2020.

(51) Int. Cl. A01N 63/22

(52) U.S. Cl. CPC A01N 63/22; A01N 63/28

(57) ABSTRACT

Disclosed are novel plant growth promoting formulations. The formulations of the present disclosure comprise microorganisms of the species Bacillus megaterium, Bacillus pumilus, Kribbella flavida, and Micrococcus luteus and can be used to promote plant growth and thereby reduce the time required to grow mature plants.

### RELATED APPLICATION

This application claims the benefit of U.S. Provisional Patent Application No. 63/031,030, filed May 28, 2020; the entire contents of Patent Application No. 63/031,030 are hereby incorporated by reference.

### FIELD OF THE DISCLOSURE

The present disclosure relates to compositions and methods to promote the growth of plants.

### BACKGROUND OF THE DISCLOSURE

The following paragraphs are provided by way of background to the present disclosure. They are not, however, an admission that anything discussed therein is prior art or part of the knowledge of persons skilled in the art.

Substantial investments are made by the agricultural and horticultural industries to research and develop new materials and techniques to improve the yield, health, and quality of planted crop- and horticultural plants. Thus, for example, research efforts are directed to developing new chemical compounds such as fertilizer compounds, fungicidal compounds, insecticidal compounds, and the like. Formulations including these compounds can be applied to plants, generally after they are planted. Other research has been directed at modulating the genetic material of plants so that genetically modified plants become predisposed to be resistant to certain diseases, or toxins. However both of these research fields have drawbacks. Chemical compounds for treating plants may adversely affect the environment and human health if not used carefully, and there is a societal stigma associated with genetically modified plants because they are poorly understood by the public.

Accordingly, there is a need in the art for compositions and methods to improve the yield, health and quality of agricultural and horticultural plants. In particular, there is a need to improve the yield, health and quality of agricultural and horticultural plants without increasing the use of chemical entities or relying on plant genetic modification techniques.

### SUMMARY OF THE DISCLOSURE

The following paragraphs are intended to introduce the reader to the more detailed description that follows and not to define or limit the claimed subject matter of the present disclosure.

In one broad aspect, the present disclosure relates to compositions facilitating plant growth. Accordingly, in one aspect, the present disclosure provides, in accordance with the teachings herein, in at least one embodiment, a plant growth promoting formulation comprising:
a growth promoting effective amount of a microbial preparation comprising a consortium of cultured microorganisms of the species Bacillus megaterium, Bacillus pumilus, Kribbella flavida, and Micrococcus luteus.

In an aspect, in at least one embodiment, the microbial formulation additionally can comprise cultured microorganisms of at least one of the genera selected from Acetobacter, Azospirillum, Azotobacter, Bacillus, Burkholderia, Frankia, Geobacillus, Microcoleus, Paenibacillus, Phormidium, Pseudomonas, Rhanella, Rhizobium, Serratia, Scytonema, Streptomyces, Synechococcus, and Tolypothrix.

In an aspect, in at least one embodiment, the microbial formulation additionally can comprise cultured microorganisms of the species Azotobacter vinelandii, Azotobacter beijerinckii, Azotobacter croococcum, or Azotobacter indicum.

In an aspect, in at least one embodiment, the microbial formulation additionally can comprise cultured microorganisms of the species Geobacillus thermoglucosidasius.

In an aspect, in at least one embodiment, the microbial formulation additionally can comprise cultured microorganisms of the species Microcoleus vaginatus.

In an aspect, in at least one embodiment, the microbial formulation additionally can comprise cultured microorganisms of the species Paenibacillus xylenexedens.

In an aspect, in at least one embodiment, the microbial formulation additionally can further comprise cultured microorganisms of the species Phormidium ambiguum.

In an aspect, in at least one embodiment, the microbial formulation additionally can comprise cultured microorganisms of the species Rhanella aquatica.

In an aspect, in at least one embodiment, the microbial formulation additionally can comprise cultured microorganisms of the species Scytonema hyalinum or Scytonema javanicum.

In an aspect, in at least one embodiment, the microbial formulation additionally can comprise cultured microorganisms of the species Streptomyces griseus or Streptomyces albogriseolus.

In an aspect, in at least one embodiment, the microbial formulation additionally can comprise cultured microorganisms of the species Tolypothrix distorta.

In an aspect, in at least one embodiment, the formulation can further comprise a carrier.

In an aspect, in at least one embodiment, the carrier can be cellulose, hydroxyethyl cellulose, carboxymethyl cellulose, gypsum, vermiculite, attapulgite clay, diatomaceous earth, lignite powder, peat, alginate, blackstrap molasses, or humic acid.

In an aspect, in at least one embodiment, the plant growth promoting formulation can comprise from about 1×10\hat{ }2 CFU per ml to about 1×10 \hat{ }8 CFU per ml or gram of each of the microorganisms.

In an aspect, in at least one embodiment, the plant can be an agricultural crop plant selected from wheat (Triticum aestivum), oat (Avena sativa), corn (Zea mays), rice (Oryza sativa), soybean (Glycine max), oilseed rape (Brassica napus), Indian mustard (Brassica juncea), sunflower (Helianthus annuus), cotton (Gossypium hirsutum), peanut (Arachis hypogaea), tomato (Solanum lycopersicum), sorghum (Sorghum bicolor), a hay grass (rye grass (Lolium spp.), timothy (Phleum pretense), brome (Bromus spp.), fescue (Festuca spp.), Bermuda grass (Cynodon spp.), orchard grass (Dactylus spp.), alfalfa (Medicago sativa), clover (Trifolium spp.)), spinach (Spinacia oleracea), celery (Apium graveolens), onion (Allium cepa), asparagus (Asparagus officinalis), pumpkin (Cucurbita spp.), squash (Cucurbita spp.), zucchini (Cucurbita pepo), garlic (Allium sativum), carrot (Daucus carota subsp. sativus), potato (Solanum tuberosum), lettuce (Lactuca sativa), bean (Phaseolus vulgaris), strawberries (Fragaria spp.), blueberries (Vaccinium spp.), bananas (Musa spp.), and hemp (Cannabis sativa Cannabis ruderalis, Cannabis indica).

In an aspect, in at least one embodiment, the plant can be a tree selected from a poplar (Populus deltoides), cottonwood (Populus section Ageiros), and a willow (Salix spp.).

In an aspect, in at least one embodiment, the plant can be a grass (Poaceae spp.) selected from Indian grass (Sorghastrum nutans), Agrostis spp., and annual bluegrass (Poa annua).

In an aspect, in at least one embodiment, the plant can be a flowering plant selected from Achillea millefolium (yarrow), Ageratum, Antirrhium majus (snapdragon), Begonia, Carophyllus (carnation), Chrysanthemum, Cineraria, Dianthus, Fuchsia, Consolida (Larkspur), Helianthus annuus (sunflower), Impatiens, Kalanchoe, Paeonia (peony), Pelargonium, Primula, Salvia, Scabiosa, Streptocarpus, Verbena bonariensis (tall verbena), and Zinnia.

In an aspect, in at least one embodiment, the plant can be grown on a plant growth substrate in need of phytoremedial treatment.

In an aspect, in at least one embodiment, the phytoremedial treatment comprises a biodegradation process, a phyto-stabilization process, a phyto-accumulation process, a rhizofiltration process, a phyto-volatilization process, a phyto-degradation process, or a hydraulic control process.

In an aspect, in at least one embodiment, the plant growth promoting formulation can be applied to a plant leaf, root or stem.

In an aspect, in at least one embodiment, the plant growth promoting formulation can be applied to a plant seed.

In an aspect, in at least one embodiment, the plant growth promoting formulation can be applied to a plant growth substrate.

In an aspect, in at least one embodiment, the plant growth promoting formulation can be applied to the seed by applying the plant growth formulation to a plant growth substrate in which the plant seed is planted.

In an aspect, in at least one embodiment, the plant growth promoting formulation can be applied to the seed by applying the plant growth formulation to a plant growth substrate in which the seed is planted, wherein the seed germination rate exceeds the seed germination rate of seed not contacted with the plant growth formulation but otherwise grown under the same conditions.

In an aspect, in at least one embodiment, the microorganisms in the consortium can be viable and can remain viable when the consortium is contacted with the plant or a plant growth substrate for the plant.

In an aspect, in at least one embodiment, the formulation can, following contact with the plant, plant part or plant growth substrate modulate in planta, at least one of sarcosine oxidase enzyme activity, phosphonate metabolism, phosphoribosyl diphosphate (PRPP) synthase enzyme activity, aminocyclopropane-1-carboxylic acid (ACC) deaminase enzyme activity, tryptophan aminotransferase (TAA) enzyme activity, YUCCA flavin monooxygenase-like enzymes activity, phytohormone concentrations, siderophore activity, or glutathione (GSH) concentrations, to thereby promote plant growth.

In another broad aspect, the present disclosure relates to methods for promoting plant growth. Accordingly, in one aspect, the present disclosure provides, in at least one embodiment, a method for promoting growth in a plant, the method comprising:
(a) contacting a plant with a plant growth promoting formulation comprising a growth promoting effective amount of a microbial preparation comprising a consortium of cultured microorganisms of the species Bacillus megaterium, Bacillus pumilus, Kribbella flavida, and Micrococcus luteus; and
(b) maintaining contact between the plant and the plant growth promoting formulation for a sufficient period of time for the consortium to microbially promote plant growth.

In an aspect, in at least one embodiment, the microbial formulation additionally can comprise cultured microorganisms of at least one of the genera selected from Acetobacter, Azospirillum, Azotobacter, Bacillus, Burkholderia, Frankia, Geobacillus, Microcoleus, Paenibacillus, Phormidium, Pseudomonas, Rhanella, Rhizobium, Serratia, Scytonema, Streptomyces, Synechococcus, and Tolypothrix.

In an aspect, in at least one embodiment, the microbial formulation additionally can comprise cultured microorganisms of the species Azotobacter vinelandii, Azotobacter beijerinckii, Azotobacter croococcum, or Azotobacter indicum.

In an aspect, in at least one embodiment, the microbial formulation additionally can comprise cultured microorganisms of the species Geobacillus thermoglucosidasius.

In an aspect, in at least one embodiment, the microbial formulation additionally can comprise cultured microorganisms of the species Microcoleus vaginatus.

In an aspect, in at least one embodiment, the microbial formulation additionally can comprise cultured microorganisms of the species Paenibacillus xylenexedens.

In an aspect, in at least one embodiment, the microbial formulation additionally can further comprise cultured microorganisms of the species Phormidium ambiguum.

In an aspect, in at least one embodiment, the microbial formulation additionally can comprise cultured microorganisms of the species Rhanella aquatica.

In an aspect, in at least one embodiment, the microbial formulation additionally can comprise cultured microorganisms of the species Scytonema hyalinum or Scytonema javanicum.

In an aspect, in at least one embodiment, the microbial formulation additionally can comprise cultured microorganisms of the species Streptomyces griseus or Streptomyces albogriseolus.

In an aspect, in at least one embodiment, the microbial formulation additionally can comprise cultured microorganisms of the species Tolypothrix distorta.

In an aspect, in at least one embodiment, the formulation can further comprise a carrier.

In an aspect, in at least one embodiment, the carrier can be cellulose, hydroxyethyl cellulose, carboxymethyl cellulose, gypsum, vermiculite, attapulgite clay, diatomaceous earth, lignite powder, peat, alginate, blackstrap molasses, or humic acid.

In an aspect, in at least one embodiment, the plant growth promoting formulation can comprise from about 1×10\hat{ }2 CFU per ml to about 1×10\hat{ }8 CFU per ml or gram of each of the microorganisms.

In an aspect, in at least one embodiment, the plant can be an agricultural crop plant selected from wheat (Triticum aestivum), oat (Avena sativa), corn (Zea mays), rice (Oryza sativa), soybean (Glycine max), oilseed rape (Brassica napus), Indian mustard (Brassica juncea), sunflower (Helianthus annuus), cotton (Gossypium hirsutum), peanut (Arachis hypogaea), tomato (Solanum lycopersicum), sorghum (Sorghum bicolor), a hay grass (rye grass (Lolium spp.), timothy (Phleum pretense), brome (Bromus spp.), fescue (Festuca spp.), Bermuda grass (Cynodon spp.), orchard grass (Dactylus spp.), alfalfa (Medicago sativa), clover (Trifolium spp.)), spinach (Spinacia oleracea), celery (Apium graveolens), onion (Allium cepa), asparagus (Asparagus officinalis), pumpkin (Cucurbita spp.), squash (Cucurbita spp.), zucchini (Cucurbita pepo), garlic (Allium sativum), carrot (Daucus carota subsp. sativus), potato (Solanum tuberosum), lettuce (Lactuca sativa), bean (Phaseolus vulgaris), strawberries (Fragaria spp.), blueberries (Vaccinium spp.), bananas (Musa spp.), and hemp (Cannabis sativa, Cannabis ruderalis, Cannabis indica).

In an aspect, in at least one embodiment, the plant can be a tree selected from a poplar (Populus deltoides), cottonwood (Populus section Ageiros), and a willow (Salix spp.).

In an aspect, in at least one embodiment, the plant can be a grass (Poaceae spp.) selected from Indian grass (Sorghastrum nutans), Agrostis spp., and annual bluegrass (Poa annua).

In an aspect, in at least one embodiment, the plant can be a flowering plant selected from Achillea millefolium (yarrow), Ageratum, Antirrhium majus (snapdragon), Begonia, Carophyllus (carnation), Chrysanthemum, Cineraria, Dianthus, Fuchsia, Consolida (Larkspur), Helianthus annuus (sunflower), Impatiens, Kalanchoe, Paeonia (peony), Pelargonium, Primula, Salvia, Scabiosa, Streptocarpus, Verbena bonariensis (tall verbena), and Zinnia.

In an aspect, in at least one embodiment, the plant can be grown on a plant growth substrate in need of phytoremedial treatment.

In an aspect, in at least one embodiment, the phytoremedial treatment includes a biodegradation process, a phyto-stabilization process, a phyto-accumulation process, a rhizofiltration process, a phyto-volatilization process, a phyto-degradation process, or a hydraulic control process.

In an aspect, in at least one embodiment, a plurality of plants can be grown from seed on a plant growth substrate to which the plant growth formulation has been applied, wherein the seed germination rate exceeds the seed germination rate of seed not contacted with the plant growth formulation but otherwise grown under the same conditions.

In an aspect, in at least one embodiment, the microorganisms in the consortium can be viable and can remain viable when the consortium is contacted with the plant or a plant growth substrate for the plant.

In an aspect, in at least one embodiment, the formulation can, following contact with the plant, plant part or plant growth substrate modulate in planta, at least one of sarcosine oxidase enzyme activity, phosphonate metabolism, phosphoribosyl diphosphate (PRPP) synthase enzyme activity, aminocyclopropane-1-carboxylic acid (ACC) deaminase enzyme activity, tryptophan aminotransferase (TAA) enzyme activity, YUCCA flavin monooxygenase-like enzymes activity, phytohormone concentrations, siderophore activity, or glutathione (GSH) concentrations, to thereby promote plant growth.

In another broad aspect, the present disclosure provides a use of a composition comprising a consortium of cultured microorganisms. Accordingly, in one aspect, the present disclosure provides, in at least one embodiment, a use of a microbial preparation comprising a consortium of cultured microorganisms of the species Bacillus megaterium, Bacillus pumilus, Kribbella flavida, and Micrococcus luteus to prepare a plant growth promoting formulation for application to a plant or part thereof or to a growth substrate for the plant to thereby promote growth of the plant, wherein the plant growth promoting formulation comprises a growth promoting effective amount of the consortium of cultured microorganisms.

In another broad aspect, the present disclosure provides a use of a plant growth promoting formulation. Accordingly, in one aspect the present disclosure provides, in at least one embodiment, a use of a plant growth promoting formulation comprising a microbial preparation of a growth promoting effective amount of a consortium of cultured microorganisms comprising the species Bacillus megaterium, Bacillus pumilus, Kribbella flavida, and Micrococcus luteus for application to a plant or part thereof or to a growth substrate for the plant, and thereafter promote growth of the plant.

Other features and advantages will become apparent from the following detailed description. It should be understood, however, that the detailed description, while indicating preferred implementations of the disclosure, are given by way of illustration only, since various changes and modifications within the spirit and scope of the disclosure will become apparent to those of skill in the art from the detailed description.

### BRIEF DESCRIPTION OF THE DRAWINGS

The disclosure is in the hereinafter provided paragraphs described, by way of example, in relation to the attached figures. The figures provided herein are provided for a better understanding of the example embodiments and to show more clearly how the various embodiments may be carried into effect. The figures are not intended to limit the present disclosure.

FIGS. 1A, 1B, 1C, and 1D show photographs of varieties of hemp plants (variety 322 (FIG. 1A), variety 321 (FIG. 1B), variety 142 (FIG. 1C), and variety 785 (FIG. 1D) grown in soil treated with a plant growth formulation according to the present disclosure (plants on the right hand side in each photograph) and plants grown in soil treated with a control formulation (plants on the left hand side in each photograph).

FIGS. 2A, 2B, 2C, and 2D show graphs obtained in the performance of certain experiments. In each of FIGS. 2A-2D are shown (a) a bar graph indicating the number of germinating plants/day; (b) a pie chart indicating the germination rate; and (c) a bar graph indicating average plant height 9 days from germination for the following hemp varieties: variety 322 (FIG. 2A), variety 321 (FIG. 2B), variety 142 (FIG. 2C) and variety 785 (FIG. 2D). Darker shaded bars and pie charts indicate the results for plants grown in soil treated with a plant growth formulation according to the present disclosure. Lighter shaded bars and pie charts indicate the results for plants grown in soil with a control formulation.

FIG. 3 shows a bar graph obtained in the performance of certain experiments. The bar graph shows germination rates of hemp plants (combined varieties 322, 321, 142 and 785). Darker shaded bars indicate the results for plants grown in soil treated with a plant growth formulation according to the present disclosure. Lighter shaded bars indicate the results for plants grown in soil with a control formulation.

FIGS. 4A, 4B, 4C and 4D show graphs obtained in the performance of certain experiments. The bar graphs show plant vigor (FIG. 4A) and total germination rate (FIG. 4B) of hemp plants (combined varieties 322, 321, 142 and 785). Darker shaded bars indicate the results for plants grown in soil treated with a plant growth formulation according to the present disclosure. Lighter shaded bars indicate the results for plants grown in soil with a control formulation. FIGS. 4C and 4D show parameters and graphs based on four-parameter Hill function (FPHF) functions relating to germination data collected for hemp plant variety 142 seeds germinating in soil treated with a plant growth formulation according to the present disclosure (FIG. 4D) and hemp plant variety 142 seeds germinating in soil treated with a control formulation (FIG. 4C). Indicated in each graph are: the rate of germination curve (“RoG curve”), fitted cumulative germination curve (“FCGC curve”), mean germination time (“MGT”), time at maximum germination (“TMGR”), time for 50% of seed to germinate (“t_{50Germ}”), time for x % (x=50) of the seed to germinate (“T_{50Total}”) and, the time interval during which between 10% and 90% of all seeds have germinated “(U₉₀-U₁₀)”.

FIG. 5 shows a photograph of two representative hemp plants (variety 322), a plant grown in soil treated with a plant growth formulation according to the present disclosure (plant on the left hand side) and a plant grown in soil treated with a control formulation (plant on the right hand side).

FIGS. 6A, 6B, 6C, 6D, 6E, 6F and 6G show results obtained in the performance of certain experiments. The bar graphs show leaf coverage (FIG. 6A) and yield (FIG. 6B) of carrots, spinach, garlic, potato, and pumpkin plants. Darker shaded bars indicate the results for plants grown in soil treated with a plant growth formulation according to the present disclosure. Lighter shaded bars indicate the results for plants grown in soil with a control formulation (FIG. 6A). Photographs show representative harvested pumpkins (FIG. 6C), pumpkin plants (FIG. 6D) grown in soil treated with a plant growth formulation according to the present disclosure (pumpkin and plants on the right hand side) and a plant grown in soil treated with a control formulation (pumpkin and plants on the left hand side), spinach (FIG. 6E), onions (FIG. 6F) and beans (FIG. 6G), treated (“Treatment”) and untreated with a plant growth formulation according to the present disclosure (“Control”).

The figures together with the following detailed description make apparent to those skilled in the art how the disclosure may be implemented in practice.

### DETAILED DESCRIPTION OF THE DISCLOSURE

Various compositions, methods or processes will be described below to provide an example of an embodiment of each claimed subject matter. No embodiment described below limits any claimed subject matter and any claimed subject matter may cover processes, compositions or methods that differ from those described below. The claimed subject matter is not limited to compositions, processes or methods having all of the features of any one composition, system or process described below or to features common to multiple or all of the compositions, systems or methods described below. It is possible that a composition, method or process described below is not an embodiment of any claimed subject matter. Any subject matter disclosed in a composition, method or process described below that is not claimed in this document may be the subject matter of another protective instrument, for example, a continuing patent application, and the applicant(s), inventor(s) or owner(s) do not intend to abandon, disclaim or dedicate to the public any such subject matter by its disclosure in this document.

As used herein and in the claims, the singular forms, such as “a”, “an” and “the” include the plural reference and vice versa unless the context clearly indicates otherwise. Throughout this specification, unless otherwise indicated, “comprise,” “comprises” and “comprising” are used inclusively rather than exclusively, so that a stated integer or group of integers may include one or more other non-stated integers or groups of integers. The term “or” is inclusive unless modified, for example, by “either”. The term “and/or” is intended to represent an inclusive or. That is “X and/or Y” is intended to mean X or Y or both, for example. As a further example, X, Y, and/or Z is intended to mean X or Y or Z or any combination thereof.

When ranges are used herein for physical properties, such as molecular weight, or chemical properties, such as chemical formulae, all combinations and sub-combinations of ranges and specific embodiments therein are intended to be included. Other than in the operating examples, or where otherwise indicated, all numbers expressing quantities of ingredients or reaction conditions used herein should be understood as modified in all instances by the term “about.” The term “about” when referring to a number or a numerical range means that the number or numerical range referred to is an approximation within experimental variability (or within statistical experimental error), and thus the number or numerical range may vary between 1% and 15% of the stated number or numerical range, as will be readily recognized by context. Furthermore any range of values described herein is intended to specifically include the limiting values of the range, and any intermediate value or sub-range within the given range, and all such intermediate values and sub-ranges are individually and specifically disclosed (e.g. a range of 1 to 5 includes 1, 1.5, 2, 2.75, 3, 3.90, 4, and 5). Similarly, other terms of degree such as “substantially” and “approximately” as used herein mean a reasonable amount of deviation of the modified term such that the end result is not significantly changed. These terms of degree should be construed as including a deviation of the modified term if this deviation would not negate the meaning of the term it modifies.

Unless otherwise defined, scientific and technical terms used in connection with the formulations described herein shall have the meanings that are commonly understood by those of ordinary skill in the art. The terminology used herein is for the purpose of describing particular embodiments only, and is not intended to limit the scope of the present invention, which is defined solely by the claims.

All publications, patents and patent applications are herein incorporated by reference in their entirety to the same extent as if each individual publication, patent or patent application was specifically and individually indicated to be incorporated by reference in its entirety.

### Terms and Definitions

The term “consortium”, as used herein, refers to a mixed-culture of a micro-organism based product capable of microbial propagation that can be used, for example, as a seed culture to inoculate a medium or substrate.

The term “cultured”, as used herein, refers to one or more microorganisms isolated from a natural environment in which the microorganism(s) occur, and held under conditions suitable to propagate the microorganisms outside the natural environment, for example, in a laboratory.

The term “growth promoting effective amount”, as used herein, refers to an amount of a formulation sufficient to promote growth of a plant or plant part, for example, a formulation that includes microorganisms, in such a manner that plant development, is accelerated as can be determined, for example, by measuring biomass production during a certain period of time, or plant seed germination rate, and by comparing plant development of one or more plants or plant parts that have been treated with the formulation with plant development of plants or plant parts that have not been treated with the formulation, and can fall in relatively wide range that can be determined by routine trials.

The term “plant”, as used herein, refers to any organism of the kingdom Planta, and includes any and all crop plants used for agricultural purposes, including all agricultural crop plants, corn, wheat, rice and soybean, for example, all horticultural plants, all floricultural plants, all trees, and further including all species, subspecies, plant cultivars, varieties, hybrids and genotypes.

Microorganisms are referred to herein by Latin names in accordance with the Linnaean taxonomic biological classification system. Accordingly, reference is made to microorganisms which can be identified with reference to certain genus, species, subspecies and strain names. In each instance, non-genetically modified and genetically modified microorganisms are intended to be included. Similarly, plant species may be referred herein by their Latin names, as well as their English names.

### General Implementation

As hereinbefore mentioned, the present disclosure relate to compositions and methods for promoting plant growth. The compositions and methods of the present disclosure promote the growth of plants by accelerating plant development, and thus plants can reach maturity faster. This can, for example, allow crop plants to grow and reach maturity in a geographical region with a shorter growing season. One further attractive feature of the present disclosure, is that the compositions of the present disclosure can be formulated using naturally occurring microorganisms.

In what follows specific example embodiments are described.

In accordance herewith, in one aspect, the present disclosure provides, in at least one embodiment, a plant growth promoting formulation comprising: a growth promoting effective amount of a microbial preparation comprising a consortium of cultured microorganisms of the species Bacillus megaterium, Bacillus pumilus, Kribbella flavida, and Micrococcus luteus.

In an aspect, in further selected embodiments, additional cultured microorganisms may be included in the microbial formulation.

In one selected embodiment, the microbial formulation additionally can comprise cultured microorganisms of one or more species selected from one or more of the genera Acetobacter, Azospirillum, Azotobacter, Bacillus, Burkholderia, Frankia, Geobacillus, Microcoleus, Paenibacillus, Phormidium, Pseudomonas, Rhanella, Rhizobium, Serratia, Scytonema, Streptomyces, Synechococcus, and Tolypothrix.

In one selected embodiment, the microbial formulation additionally can comprise cultured microorganisms of one or more Azotobacter species selected from Azotobacter vinelandii, Azotobacter beijerinckii, Azotobacter croococcum, and Azotobacter indicum.

In one selected embodiment, the microbial formulation additionally can comprise cultured microorganisms of the species Geobacillus thermoglucosidasius.

In one selected embodiment, the microbial formulation additionally can comprise cultured microorganisms of the species Microcoleus vaginatus.

In one selected embodiment, the microbial formulation additionally can comprise cultured microorganisms of the species Paenibacillus xylenexedens.

In one selected embodiment, the microbial formulation additionally can comprise cultured microorganisms of the species Phormidium ambiguum.

In one selected embodiment, the microbial formulation additionally can comprise cultured microorganisms of the species Rhanella aquatica.

In one selected embodiment, the microbial formulation additionally can comprise cultured microorganisms of one or more Scytonema species selected from Scytonema hyalinum or Scytonema javanicum.

In one selected embodiment, the microbial formulation additionally can comprise cultured microorganisms of one or more of the Streptomyces species Streptomyces griseus or Streptomyces albogriseolus.

In one selected embodiment, the microbial formulation additionally can comprise cultured microorganisms of the species Tolypothrix distorta.

It is to be understood that any and all combinations of the aforementioned additional cultured microorganisms may be included in the microbial formulations of the present disclosure. Thus, by way of example only, in different selected embodiments, the consortium may comprise one additional species e.g. Streptomyces griseus, Rhanella aquatica, or Paenibacillus xylenexedens. In other selected embodiments, the consortium may comprise two additional species, e.g. Streptomyces griseus and Rhanella aquatica, or Streptomyces griseus and Paenibacillus xylenexedens, or Paenibacillus xylenexedens and Rhanella aquatica. In yet another selected embodiment, the consortium may additionally comprise three additional species e.g. Streptomyces griseus, Rhanella aquatica, and Paenibacillus xylenexedens.

Initially a substantially pure aliquot of each of the microorganisms of the present disclosure can be obtained from a microorganism culture collection, for example, from the American Type Culture Collection (ATCC), NRRL, or a similar collection, or from private companies such as BioSource Flavors Inc., The BioCollective, LLC, Pure Cultures Inc., Nutraceutix Inc, or PaleoBiotica, Inc., for example. Upon obtaining an aliquot of a microorganism a quantity thereof can be used to inoculate a suitable growth medium and the microorganism can be grown in quantities, as desired, and cultured under appropriate conditions, for example, in a liquid growth medium comprising appropriate microbial nutrients under growth promoting conditions. Thereafter the microorganisms can be harvested under conditions ensuring that viable microorganisms are retained from the medium, and the harvested microorganisms can be used to prepare the plant growth promoting formulations of the present disclosure. In some embodiments, the species included in the formulation can be co-cultured, or alternatively, the species can initially be separately grown and mixed upon harvesting. General growing conditions for cultivating and growing the microbial species of the present disclosure include growth on agar based media, such as MRS agar or MRS liquid media, as described in de Man, J. D.; Rogosa, M.; Sharpe, M. E. (1960): “A Medium for the Cultivation of Lactobacilli”, J. Appl Bact. 23 (130-135). Bacillus megaterium, Bacillus pumilus, Kribbella flavida, and Micrococcus luteus, may all be grown using sterile MRS growth media, or modifications thereof. Microbial species belonging to the genus Acetobacter, Azospirillum, Azotobacter, Bacillus, Burkholderia, Frankia, Geobacillus, Microcoleus, Paenibacillus, Phormidium, Pseudomonas, Rhanella, Rhizobium, Serratia, Scytonema, Streptomyces, Synechococcus, and Tolypothrix may be grown on, for example, Trypticase Soy Broth (TSB), or Tryptone-Yeast Extract-Glucose Agar (TGY).

Further growth media that may be used include Nutrient Broth, Luria-Bertine broth (LB-broth), and ISP medium #1, or modifications thereof.

MRS growth medium can contain, for example:

1.0% peptone

1.0% beef extract

0.4% yeast extract

2.0% glucose

0.5% sodium acetate trihydrate

0.1% polysorbate 80 (also known as Tween 80)

0.2% dipotassium hydrogen phosphate

0.2% triammonium citrate

0.02% magnesium sulfate heptahydrate

0.005% manganese sulfate tetrahydrate

1.0% agar

pH adjusted to 6.2 at 25° C.

TSB growth medium can contain, for example:

Tryptone (Pancreatic Digest of Casein) 17.0 g/L water

Soytone (Peptic Digest of Soybean) 3.0 g/L water

Glucose (=Dextrose) 2.5 g/L water

Sodium Chloride 5.0 g/L water

Dipotassium phosphate 2.5 g/L water

pH 7.3±0.2

Nutrient Broth can contain, for example:

Beef extract 3 g/L water

Peptone 5 g/L water

LB broth can contain, for example:

Peptone 140 10 g/L water;

Yeast extract 5 g/L water,

NaCl 5 g/L water

ISP medium #1 can contain, for example:

ISP #1: Tryptone (BD 211705) 5.0 g/L water

Yeast extract 3.0 g/L water

Agar (optional) 15.0 g/L water.

TGY medium can contain, for example:

Tryptone 5.0 g/L water

Yeast extract 5.0 g/L water

KH₂PO₄ 1.0 g/L water

Glucose 1.0 g/L water

15.0 g/L water

PH=7.0

Growth conditions may vary but can include, for example, growth in a flask or other suitable growth vessel containing liquid MRS or MRS agar inoculated with an inoculating quantity of a microorganism, between 20° C. and 37° C., for a period of 12-36 hrs under agitation, such as for example, imparted by a temperature controlled standard incubator-shaker for the cultivation of microorganisms, as will be known to those of skill in the art. If desired, larger quantities of the microorganisms may be obtained by scaling up growth and recovery equipment and increasing the quantities of growth media, for example, by using fermentation equipment, such as bioreactors and fermenters. Further guidance regarding growth of microorganisms in bioreactors may be found in for example: H. P. Meyer et al. in: Industrial Biotechnology: Products and Processes, 2017, First Edition, Whittmann and Liao, Wiley-VCH Verlag GmbH.

In order to prepare the plant growth promoting formulations of the present disclosure, a quantity of each Bacillus megaterium, Bacillus pumilus, Kribbella flavida, Micrococcus luteus and, optionally, one or more microbial species belonging to the genus Acetobacter, Azospirillum, Azotobacter, Bacillus, Burkholderia, Frankia, Geobacillus, Microcoleus, Paenibacillus, Phormidium, Pseudomonas, Rhanella, Rhizobium, Serratia, Scytonema, Streptomyces, Synechococcus, and Tolypothrix may be obtained and mixed to obtain a microbial preparation including each of the microbial species Bacillus megaterium, Bacillus pumilus, Kribbella flavida, Micrococcus luteus, and, optionally, one or more microbial species belonging to the genus Acetobacter, Azospirillum, Azotobacter, Bacillus, Burkholderia, Frankia, Geobacillus, Microcoleus, Paenibacillus, Phormidium, Pseudomonas, Rhanella, Rhizobium, Serratia, Scytonema, Streptomyces, Synechococcus, and Tolypothrix. In one embodiment, a microbial preparation of each Bacillus megaterium, Bacillus pumilus, Kribbella flavida, Micrococcus luteus and, optionally, one or more microbial species belonging to the genus Acetobacter, Azospirillum, Azotobacter, Bacillus, Burkholderia, Frankia, Geobacillus, Microcoleus, Paenibacillus, Phormidium, Pseudomonas, Rhanella, Rhizobium, Serratia, Scytonema, Streptomyces, Synechococcus, and Tolypothrix is obtained in a concentration sufficient to prepare a plant growth promoting formulation comprising a plant growth promoting effective amount of a consortium preparation of the microorganisms, for example, a microbial preparation that allows a finished plant growth promoting formulation to comprise from about 1×10\hat{ }2 Colony Forming Units (CFU) to about 1×10\hat{ }8 CFU of each species per milliliter or per gram, and CFU values therebetween, for example, about 1×10\hat{ }2 CFU, about 5×10\hat{ }2 CFU, about 1×10\hat{ }3 CFU, about 5×10\hat{ }3 CFU, about 1×10\hat{ }4 CFU, about 5×10\hat{ }4 CFU, about 1×10\hat{ }5 CFU, about 5×10\hat{ }5 CFU, about 1×10\hat{ }6 CFU, about 5×10\hat{ }6 CFU, about 1×10\hat{ }7 CFU, about 5×10\hat{ }7 CFU, or about 1×10\hat{ }8 CFU per milliliter or per milligram. In this manner, a microbial preparation can be obtained. The microbial preparation can then be used per gram or ml of formulation to prepare a plant growth promoting formulation. Plant growth promoting formulations, as used herein, are formulations comprising a microbial preparation formulated together with one or more additional formulary ingredients

Formulary ingredients may vary but include a diluent, for example, an aqueous solution, such as water or a buffer, excipients or a carrier. Example carriers that may be used in this respect include cellulose, hydroxyethyl cellulose, carboxymethyl cellulose, gypsum, vermiculite, attapulgite clay, diatomaceous earth, lignite powder, peat, alginate, blackstrap molasses, or humic acid, or, in general, any other carrier that may be used in the preparation of agricultural formulations. It is further noted that the formulary ingredients may vary, depending on the use of the final formulation, which may vary as hereinafter further described. In general, formulary ingredients can be contacted with a microbial preparation and mixed or prepared until a plant growth promoting formulation is obtained. As will be clear to those of skill in the art, formulation conditions will generally be such that viable microorganisms are retained. In particular, high temperatures, for example, temperatures in excess of 40° C., are preferably avoided in the formulation process. It is further noted that the physical constituency of the plant growth promoting formulations in accordance herewith can vary substantially and can include solid or semisolid formulations, such as powders, as well as liquid formulations, including for example pourable or sprayable liquid formulations.

Upon formulation, the plant growth promoting formulations of the present disclosure can be directly used for plant growth promoting purposes, including, for example, by application of the plant growth formulation to a plant, a plant part, or a plant growth substrate. The term “plant growth substrate”, as used herein, is intended to include any composition, material, medium product, substance, or portion thereof, which can be used to provide adequate aeration, nutrient and water supply to support plant growth, including soil, turf, a hydroponic substrate, or substrates for soilless culture systems (SCS), such as rockwool, vermiculite, pumice, volcanic rock, for example. The plant growth promoting formulation may be applied to a plant or plant part. A plant part, in this respect includes a plant organ, structure or tissue, such as a leaf, stem or root, and further includes regenerative plant parts from which a whole plant can be generated such as plant seeds, or plant tissues that allow for regeneration of a whole plant, such as may be used in the practice of plant tissue culture techniques. When applied to seed, the plant growth formulation may facilitate seed germination.

Thus, as noted, in some embodiments, the plant growth promoting formulation may be applied to plant seeds. Such application may involve contacting the seed with the plant growth formulation prior to planting the seed, for example, by soaking the seed in a liquid plant growth promoting formulation for a brief period of time, for example, about 1 to 24 hours, or wiping the seed with the plant growth formulation. The plant seed may also be contacted with the plant growth promoting formulation after the seed has been planted in a plant growth substrate, for example by pouring a liquid plant growth formulation onto the plant growth substrate.

The plant growth promoting formulation of the present disclosure may be applied to a plant or part thereof, or to a plant growth substrate once, or it may be applied repeatedly depending on, for example, the growth stage of the plant. Furthermore, the quantity of the plant growth promoting formulation applied to the plant or part thereof or the plant growth substrate may be varied and adjusted. When applied to a growth substrate, amounts of the formulation that may be used include amounts ranging from about 1×10\hat{ }4 CFU per m² of growth substrate to about 1×10¹⁰ CFU per m² of growth substrate, and CFU values per m² therebetween. When applied to soil, the growth promoting formulation is generally applied to the top soil, e.g. at a depth of no more than 15 cm from the soil surface, or, for example, 10-15 cm or 5-15 cm below the soil surface.

Furthermore, the application techniques maybe varied and adjusted, for example, the plant growth promoting formulation may be sprayed upon the plant or part thereof or the plant growth substrate, wiped onto the plant or part thereof or a substrate for growth of the plant, or poured in or on the plant or part thereof or the substrate for growth of the plant, for example. Furthermore, application conditions may be varied, for example, temperatures and total application time. The effect of such variations in application of the plant growth promoting formulation may be evaluated by a person of skill in the art, for example by evaluating plant growth promoting using various application techniques or conditions and comparing plant growth under these different conditions and application techniques. Thus, for example, plant growth may be evaluated by measuring biomass production for a certain duration of time, for example, by weighing the produced biomass, or, for example, plant height may be evaluated, or, for example, plant leaf coverage may be evaluated. Furthermore, seed germination parameters, such as, the seed germination rate (i.e. the percentage of planted seeds germinating), the mean germination time, time to maximum germination rate, and time to achieve 50% of seed germination, may be evaluated and compared using various application techniques or conditions and compared under these different conditions and application techniques. As will be appreciated, by those of skill in the art, the evaluation results may be used to adjust application conditions and techniques to obtain a desirable growth promoting effect.

In some embodiments, the plant growth promoting formulations may be co-applied with a fertilizer formulation, for example, a phosphate fertilizer. Without wishing to be bound by theory, in this respect, the microorganisms in the plant growth promoting formulations may solubilize or mineralize fertilizer compounds, for example, phosphate compounds, to thereby enhance the bioavailability of the phosphorus compounds to plants.

In an aspect hereof, the plant to which the plant growth formulations are applied, can be any plant, including any agricultural plant, including any agricultural crop plant, horticultural plant, or floricultural plant.

In selected embodiments, the plant can be an agricultural crop plant, including, for example, an agricultural crop plant selected from wheat (Triticum aestivum), oat (Avena sativa), corn (Zea mays), rice (Oryza sativa), soybean (Glycine max), oilseed rape (Brassica napus), Indian mustard (Brassica juncea), sunflower (Helianthus annuus), cotton (Gossypium hirsutum), peanut (Arachis hypogaea), tomato (Solanum lycopersicum), sorghum (Sorghum bicolor), a hay grass (including, without limitation: rye grass (Lolium spp.), timothy (Phleum pretense), brome (Bromus spp.), fescue (Festuca spp.), Bermuda grass (Cynodon spp.), orchard grass (Dactylus spp.), alfalfa (Medicago sativa), clover (Trifolium spp.)), spinach (Spinacia oleracea), celery (Apium graveolens), onion (Allium cepa), asparagus (Asparagus officinalis), pumpkin (Cucurbita spp.), squash (Cucurbita spp.), zucchini (Cucurbita pepo), garlic (Allium sativum), carrot (Daucus carota subsp. sativus), potato (Solanum tuberosum), lettuce (Lactuca sativa), bean (Phaseolus vulgaris), strawberries (Fragaria spp.), blueberries (Vaccinium spp.), bananas (Musa spp.), and hemp (Cannabis sativa, Cannabis ruderalis, Cannabis indica).

In further selected embodiments, the plant can be a tree, including, for example, a tree selected from a poplar (Populus deltoides), cottonwood (Populus section Ageiros), and a willow (Salix spp.).

In further selected embodiments, the plant can be a grass (Poaceae spp.), including, for example, a grass selected from Indian grass (Sorghastrum nutans), Agrostis spp., and annual bluegrass (Poa annua).

In further selected embodiments, the plant can be a flowering plant, including, for example, a flowering plant selected from Achillea millefolium (yarrow), Ageratum, Antirrhium majus (snapdragon), Begonia, Carophyllus (carnation), Chrysanthemum, Cineraria, Dianthus, Fuchsia, Consolida (Larkspur), Helianthus annuus (sunflower), Impatiens, Kalanchoe, Paeonia (peony), Pelargonium, Primula, Salvia, Scabiosa, Streptocarpus, Verbena bonariensis (tall verbena), and Zinnia.

In further selected embodiments, the plant can be a plant grown on a plant growth substrate, wherein the growth substrate is in need of phytoremedial treatment. The term “phytoremedial treatment”, as used herein, means a remedial treatment of a plant growth substrate to remove, transfer, stabilize, or destroy an undesirable chemical compound present in the substrate, such as a toxic compound present in soil or water, a heavy metal (e.g. lead, zinc, cadmium, arsenic, cobalt, copper, uranium), a petroleum hydrocarbon, a polycyclic aromatic hydrocarbon, or a pesticide, for example. Phytoremedial treatment, in accordance herewith, can include the conduct of multiple phytoremedial processes aided by the growth of the plant, including, for example, a rhizosphere biodegradation process, a phyto-stabilization process, a phyto-accumulation process, a rhizo-filtration process, a phyto-volatilization process, a phyto-degradation process, or a hydraulic control process.

Thus, for example, phytoremedial treatment can involve a rhizosphere biodegradation process, i.e. the degradation of toxic compounds present in the soil influenced by plant roots through substances termed root exudates (e.g. sugars, amino acids) in the substrate surrounding the plant's roots (i.e. the rhizosphere). Rhizosphere biodegradation often involves microbial organisms, for example, a hydrocarbon or alkaloid degrading microorganism, present in the soil surrounding the plant's roots, which are stimulated by the root exudates. Thus, for example, rice can degrade the alkaloid herbicide propanil in the rhizosphere (Hoagland et al., 1994, In T. A. Anderson and J. R. Coats (eds.), Bioremediation Through Rhizosphere Technology, ACS Symposium Series, Volume 563. American Chemical Society, Washington, D.C.).

By way of further example, phytoremedial treatment can involve a phyto-stabilization process, i.e. the containment of toxic compounds to thereby reduce the mobility of contaminants, for example, heavy metals through plant soil. This may be achieved by precipitation of contaminants in a plant root zone, or by absorption or accumulation of toxic compounds by plant roots. Thus, in this manner contaminants may be concentrated. In addition, phyto-stabilization processes may be enhanced by plant growth as a result of a reduction in wind or water erosion, thus limiting soil movement. For example, roots can mediate the precipitation of lead as insoluble lead phosphate (Salt, D. E. et al., 1995, Biotechnol. 13: 468-474).

By way of further example, phytoremedial treatment can involve a phyto-accumulation process (also known as phyto-extraction), i.e. the accumulation and concentration of toxic compounds in a plant, generally from soil, and generally in the above ground portion of the plant. Plants may subsequently be harvested and disposed as hazardous waste, or the toxic compounds may be recovered and re-used. Thus, for example, metals (e.g., Ag, Cd, Co, Cr, Cu, Hg, Mn, Mo, Ni, Pb, Zn), metalloids (e.g., As, Se), radionuclides (e.g., ⁹⁰Sr, ¹³⁷Cs, ²³⁴U, ²³⁸U), and non-metals (e.g., B) may be phyto-accumulated (Salt, D. E. et al., 1995, Biotechnol. 13: 468-474, Kumar B. P. A. et al., 1995, Environ. Sci. Technol. 29(5) 1232-1238; Cornish J. E. et al., 1995, In: R. E. Hinchee, J. L. Means, and D. R. Burris (eds.), Bioremediation of Inorganics. Battelle Press, Columbus, Ohio; BaAuelos G. S. et al., 1999, Int. J. Phytoremediation 1(1): 81-96.

By way of further example, phytoremedial treatment can involve a rhizo-filtration process, i.e. the removal of toxic compounds from contaminated water, such as contaminated groundwater, waste water or surface water by absorption or adsorption or precipitation onto the roots. For example, plants grown using a hydroponic system, may be used to filter water polluted with heavy metals. Upon saturation of the plant roots with the contaminants, plant roots (and if necessary other plant parts) may be harvested and may be disposed. Rhizofiltration may be used to treat large volumes of water contaminated with metals (Pb, Cd, Cu, Fe, Ni, Mn, Zn, Cr(VI) (Dushenkov V. et al., 1995, Environ. Sci. Technol. 1239-1245. 29; Wang et al., 1996, Bull. Environ. Contam. Toxicol. 57: 779-786; Salt et al., 1997, Environ. Sci. Technol. 31(6) 1636-1644) and radionuclides (⁹⁰Sr, ¹³⁷Cs, ²³⁸U, ²³⁶U (Dushenkov V. et al., 1997, Environ. Sci. Technol. 31(12) 3468-3474)).

By way of further example, phytoremedial treatment can involve phyto-volatilization, i.e. the removal of toxic compounds, e.g. organic toxic compounds, from a contaminated plant growth substrate and subsequent release of a volatile compound, preferably a modified less toxic product, through the plant, notably the plant leaves, into the atmosphere. Thus, for example toxic selenium, as selenocyanate, may be released as less toxic dimethyl-selenide gas by Indian mustard (Souza de, M. P., 2002, Plant Physiol. 128: 625-633), and trichloroethylene and tetrachloroethylene may be phyto-volatilized by willow and poplar (Limmer, M. and Burken J. 2016, Environ. Sci. Technol. 50: 6632-6643).

By way of further example, phytoremedial treatment can involve phyto-degradation, i.e. the uptake and metabolic degradation of a chemical compound by the plant into another chemical compound. Thus, for example, the pesticide atrazine may be degraded by poplars to form less toxic dealkylated metabolites (Burken, J. G. and Schnoor J. L., 1997, Environ. Sci. Technol. 31: 1399-1406.)

By way of yet another example, phytoremedial treatment can involve hydraulic control, i.e. control of groundwater and soil water movement by uptake and consumption thereof. Thus, for example, trees can absorb large quantities of water from soil, e.g. a poplar can absorb up to 200 L water/day (Newman L. A. et al., 1997, Environ. Sci. Technol. 31: 1062-1067), a cottonwood tree can absorb up to 350 gallons of water/day (Hinckley T. M. et al., 1994, Tree Physiol. 14: 1005-1018) and thereby control the levels of contaminant compounds.

The plant growth promoting formulation promotes growth of a plant or a plant part, in such a manner that plant development is accelerated as can be determined, for example, by evaluating biomass production during a certain period of time, plant height, or time from planting to reaching plant maturity, e.g. seed-to-seed, or any other technique to evaluate plant development. This may, for example, be done by comparing plant development of one or more plants or plant parts that have been treated with a plant growth formulation according to the present disclosure, with plant development of plants or plant parts that have not been treated with the formulation.

Upon contact of the microorganisms in the consortium with the plant or part thereof or a growth substrate for the plant the microorganisms may remain viable, and thus the microorganism may propagate once contacted with, for example, soil in which the plant grows, and by propagation continue to promote plant growth. Thus, for example the microorganisms in the consortium may remain viable for a period of at least about 10 days, at least about 30 days, at least about 60 days, or at least about 90 days following contact between the consortium and the plant or plant part or plant growth substrate.

The plant growth formulation can have multiple effects in planta, notably on plant metabolism. In some embodiments, the formulation can, following contact with the plant, modulate at least one of sarcosine oxidase enzyme activity, phosphonate metabolism, phosphoribosyl diphosphate (PRPP) synthase enzyme activity, aminocyclopropane-1-carboxylic acid (ACC) deaminase enzyme activity, tryptophan aminotransferase (TAA) enzyme activity, YUCCA flavin monooxygenase-like enzymes activity, phytohormone concentrations, siderophore activity, glutathione (GSH) concentrations, to thereby promote plant growth.

Furthermore, the plant growth formulation can increase phosphate uptake by the plant, for example by solubilizing phosphate, to thereby promote plant growth.

Furthermore, the plant growth formulation can increase nitrogen uptake by the plant, for example, by converting nitrate to ammonium for plant uptake, to thereby promote plant growth.

In view of the foregoing, it will be clear that the present disclosure further relates to methods for promoting plant growth. Accordingly, in one aspect, the present disclosure provides, in at least one embodiment, a method for promoting growth in a plant, the method comprising:
(a) contacting a plant with a plant growth promoting formulation comprising a plant growth promoting effective amount of a microbial preparation comprising a consortium of cultured microorganisms of the species Bacillus megaterium, Bacillus pumilus, Kribbella flavida, Micrococcus luteus and, optionally, Streptomyces griseus; and
(b) maintaining contact between the plant and the plant growth promoting formulation for a sufficient period of time for the consortium to microbially promote plant growth.

It is noted that the period of time during which contact between the plant and the plant growth promoting formulation to microbially promote plant growth is maintained, may vary depending on, for example, the selected plant, the plant growth substrate, and the plant growth conditions. In general, upon having contacted the plant with the plant growth promoting formulation, it is not necessary to remove the formulation from the plant while the plant is growing, and thus contact is maintained, at least until the microbial consortium naturally loses its ability to promote plant growth, for example, because the microbial consortium is diluted in the growth medium, or until the plant is harvested. As hereinbefore noted, in some embodiments, the microbial consortium is capable of propagation and is viable in the growth medium. Thus the consortium may promote plant growth during the entire growth period of a plant, for example, when seed is treated with the plant growth formulation, or when the plant growth substrate is pre-treated with the plant growth formulation prior to planting. In some embodiments, contact between the plant and the plant growth formulation may be maintained for 1 week or at least for 1 week, for 1 month or at least for 1 month, for 2 months or at least for 2 months, for 3 months or at least 3 months, or for 4 months or at least 4 months, during which the growth promoting formulation promotes plant growth.

In another aspect the present disclosure provides a use of a composition comprising a consortium of cultured microorganisms. Accordingly, in one aspect the present disclosure provides, in at least one embodiment, a use of a microbial preparation comprising a consortium of cultured microorganisms of the species Bacillus megaterium, Bacillus pumilus, Kribbella flavida, Micrococcus luteus and, optionally, one or more microbial species belonging to the genus Acetobacter, Azospirillum Azotobacter, Bacillus, Burkholderia, Frankia, Geobacillus, Microcoleus, Paenibacillus, Phormidium, Pseudomonas, Rhanella, Rhizobium, Serratia, Scytonema, Streptomyces, Synechococcus, and Tolypothrix to prepare a plant growth promoting formulation for application to a plant or part thereof or to a growth substrate for the plant to thereby promote growth of the plant, wherein the plant growth promoting formulation comprises an effective amount of the consortium of cultured microorganisms.

In another aspect, the present disclosure provides a use of a plant growth promoting formulation. Accordingly, in one aspect the present disclosure provides, in at least one embodiment, a use of a plant growth promoting formulation comprising a microbial preparation of a growth promoting effective amount of a consortium of cultured microorganisms comprising the species Bacillus megaterium, Bacillus pumilus, Kribbella flavida, Micrococcus luteus and, optionally, one or more microbial species belonging to the genus Acetobacter, Azospirillum Azotobacter, Bacillus, Burkholderia, Frankia, Geobacillus, Microcoleus, Paenibacillus, Phormidium, Pseudomonas, Rhanella, Rhizobium, Serratia, Scytonema, Streptomyces, Synechococcus, and Tolypothrix for application to a plant or part thereof or to a growth substrate for the plant, and thereafter promote growth of the plant.

Hereinafter are provided examples of specific embodiments of the compositions of the present disclosure and methods of the present disclosure. The examples are provided for illustrative purposes only, and are not intended to limit the scope in any way.

### EXAMPLES

### Example 1

### Method for Obtaining a Microbial Preparation and Preparing a Plant Growth Promoting Formulation

Freezer stocks of Bacillus pumilus (PBI0001), Bacillus megaterium (PBI0114), Kribbella flavida (PBI0106), Micrococcus luteus (PBI0112) and Streptomyces griseus (PBI0129) were retrieved from the freezer and allowed to thaw at room temperature in a safety cabinet. The inocula were then prepared by pipetting 1 mL of the individual freezer stocks into 125 mL fluted, shaker flasks containing 25 mL of trypticase soy broth (TSB) and incubated at 30° C. in a shaker incubator with agitation at 200 RPM. After 24 hours, the individual flasks were inspected for growth and an aliquot is retrieved for assessment of purity by Gram staining. Once certain of the purity, the OD of each flask was measured and adjusted with sterile TSB to an OD₆₀₀ of 0.1. Fifty mL of the OD₆₀₀-adjusted inoculum was dispensed into 2 L fluted flasks with 500 mL of TSB and incubated similarly at 30° C. in a shaker incubator with agitation at 200 RPM for 24 hours. The individual broth cultures were centrifuged at 5,000×g for 5 minutes at room temperature and the cell pellet washed twice with phosphate-buffered saline (PBS). The number of CFU/mL for each culture was determined by the Standard Plate Count (Maturin L, Peeler JT. Bacteriological analytical manual chapter 3: Aerobic plate count. Food and Drug Administration. 2001.). The individual cell suspensions were then diluted in 1% sucrose solution to a concentration of 5×10⁷ CFU/mL. Equal volumes of each of the five strains were mixed together to achieve a final concentration of each of the strains of 1×10⁷ CFU/mL. This mixture, referred to as PaleoGro in Example 2 is used as a soil inoculant.

### Example 2

Plant Growth of Hemp Plants Treated with a Plant Growth Promoting Formulation

Individual seeds are obtained from supplier. A germination study was performed using PaleoGro (a mixture of Bacillus pumilus (PBI0001), Bacillus megaterium (PBI0114), Kribbella flavida (PBI0106), Micrococcus luteus (PBI0112) and Streptomyces griseus (PBI0129), prepared as described in Example 1) and four different hemp varieties (varieties 142, 321, 322, and 785). The growth medium is organic potting soil mixed with worm castings and calcium carbonate. The growth parameters are as follows: light cycle 18 hours on 6 hours off; average % humidity was 90%; average temperature was 74.6° F.; and seed depth 0.635 cm. The Treatment Group consisted of 1 mL of the PaleoGro formulation inoculated in soil/seed planted, and the Control Group use 1 mL of 1% glucose only (control formulation). The seeds were monitored for a period of 9 days. Germination rate after 7 days, Germination Growth after 9 days and overall Plant Vigor were measured.

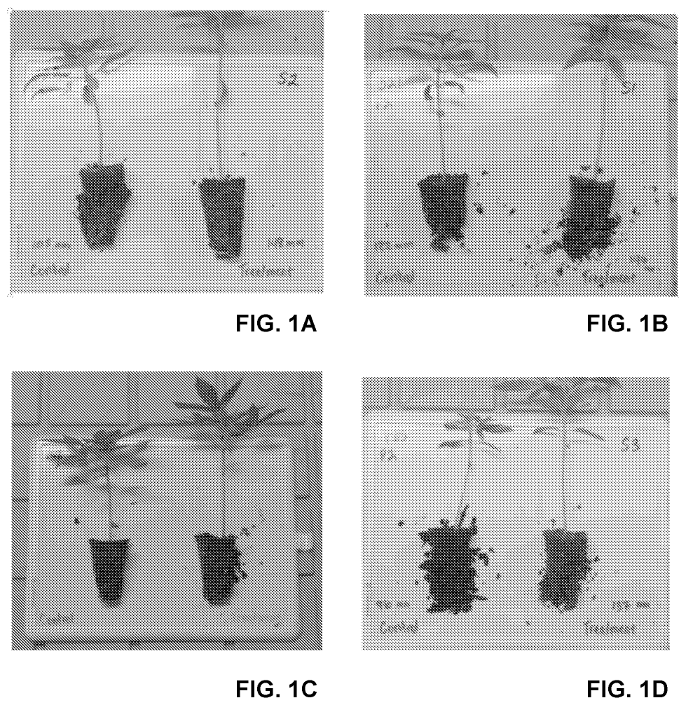

A photograph showing a representative plant of each hemp variety 9 days from seed germination is shown in FIGS. 1A-1D. Differences in height between plants grown in soil treated with PaleoGro, and plants grown in soil treated with the control formulation can be clearly seen.

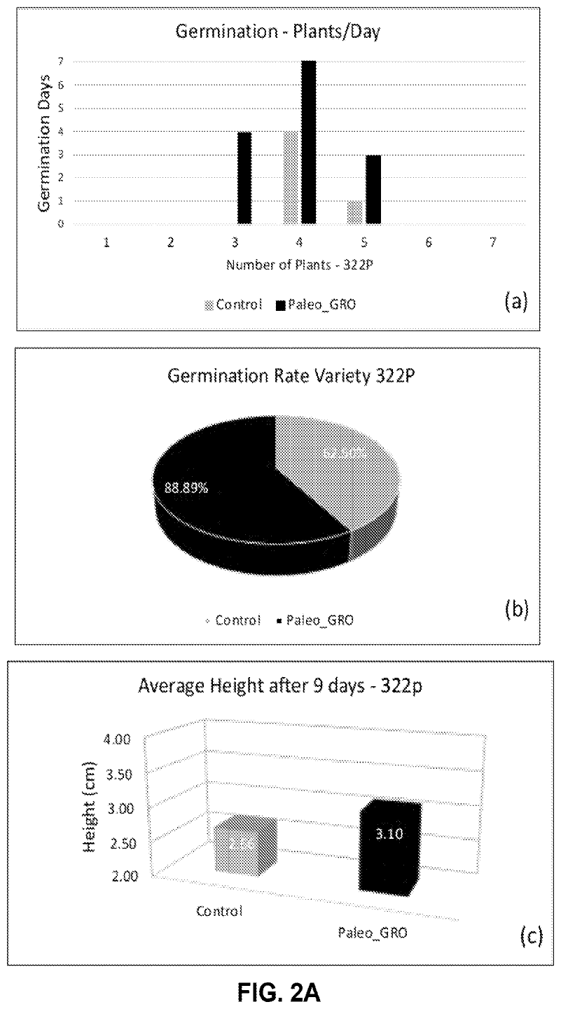

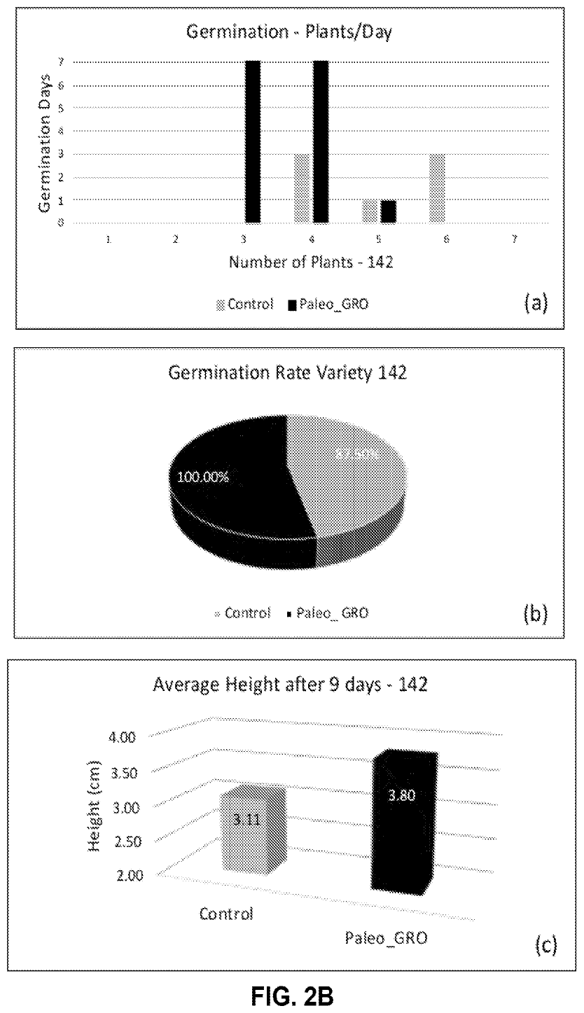

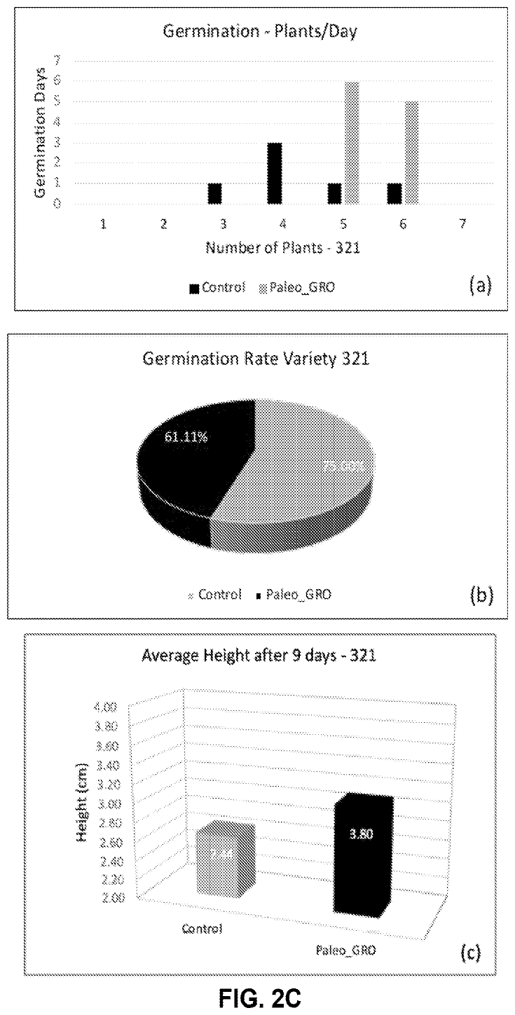

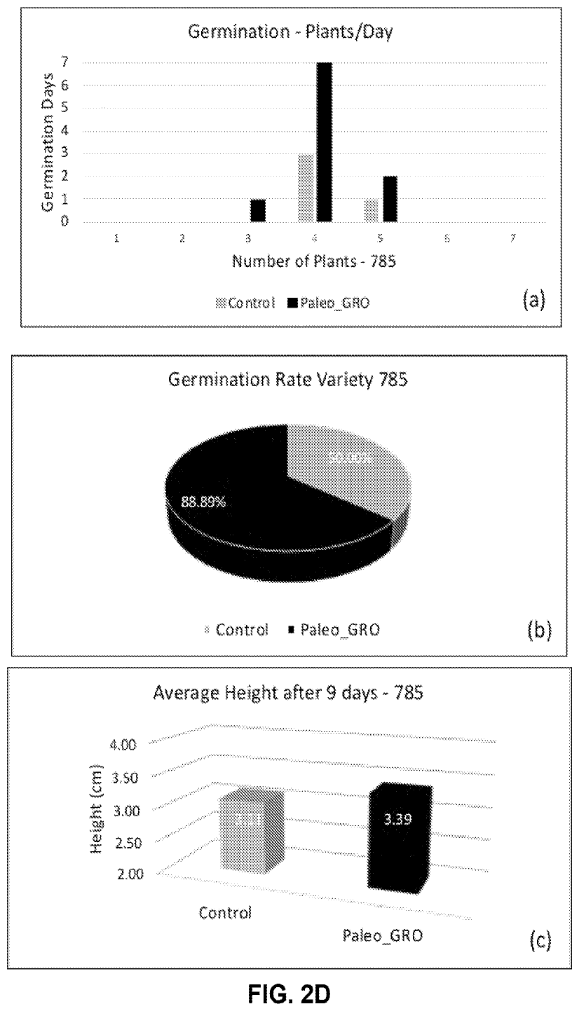

Graphed results can be seen in FIGS. 2A-2D. Notably in each of FIGS. 2A-2D are shown (a) bar graph indicating the number of germinating plants/day; (b) a pie chart indicating the germination rate; and (c) a bar graph indicating average plant height 9 days from germination for the hemp varieties as follows: variety 322 (FIG. 2A), variety 321 (FIG. 2B), variety 142 (FIG. 2C) and variety 785 (FIG. 2D). It is noted that in general, plants grown in soil treated with the control formulation germinate earlier, exhibit a higher germination rate, and achieve a greater height nine days from germination than the plants grown in soil treated with the control formulation.

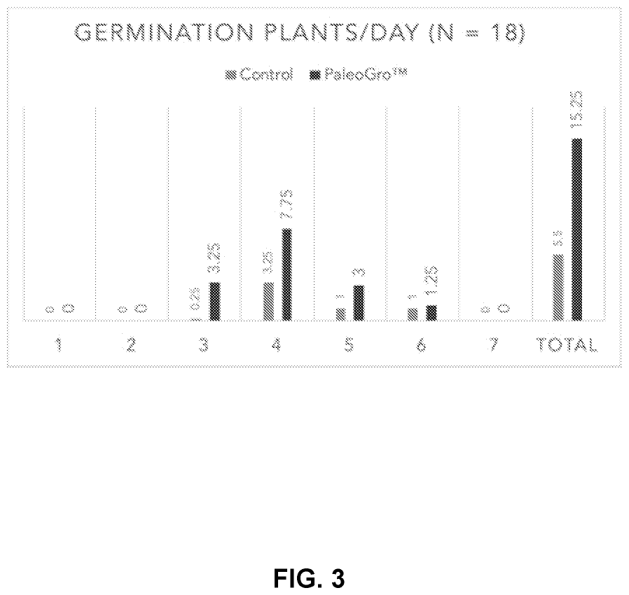

Graphed results showing the number of germinating plants per day combining all four varieties are shown in FIG. 3. It is noted that in general, plants grown in soil treated with the control formulation germinate earlier and exhibit a higher germination rate.

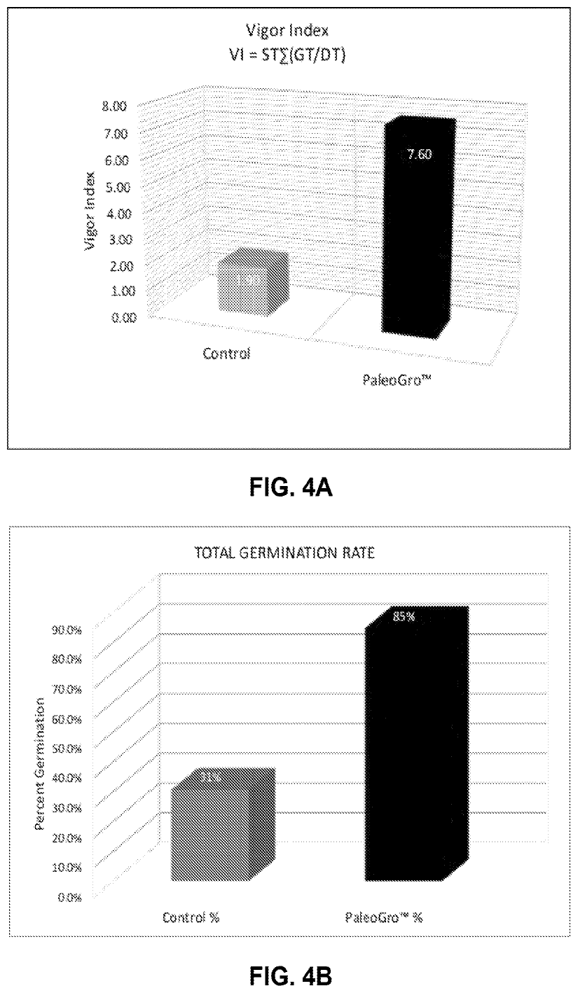

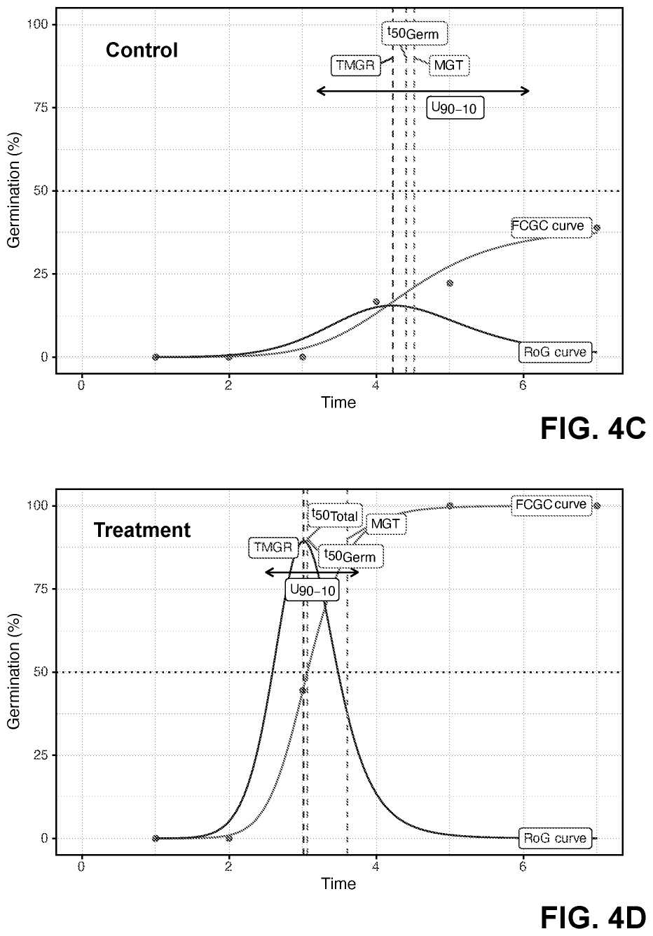

Further graphed results are shown in FIGS. 4A-4B notably with respect to plant vigor and germination rate, in both cases combining the results for all four hemp varieties. Plant vigor (also plant health or hardiness) is a measure of the increase in plant growth or foliage volume through time after planting. Plant vigor is calculated by the formula V_{I}=S_{T}Σ(G_{T}/D_{T}) [Zhu, S. Y. and Hong, D. L., 2008. Comparison between two hybrid cultivars of indica rice (Oryza sativa L.) in seed vigor and biochemical traits after aging. Chin. J. Eco Agriculture, 16, pp. 396-400]), where S is seedling height of the seventh day, Gt is number of germinated seeds in the “t th” day, Dt is number of days from the first day to the “t th” day). Plant vigor was shown to be 3-4× greater in plants grown in soil treated with PaleoGro than in plants grown in soil treated with a control formulation (FIG. 4A). The total germination rate (FIG. 4B) was found to be more than doubled when plants were grown in soil treated with PaleoGro, compared to plants grown in soil treated with a control formulation.

Further graphed results are shown in FIG. 4C and FIG. 4D, notably with respect to seed germination comparing hemp seeds (variety 142) treated with 1 mL of the PaleoGro formulation inoculated in soil/seed planted (“Treatment”, FIG. 4D), and the Control treated with 1 mL of 1% glucose (“Control”, FIG. 4C). Shown are graphs and parameters based on a four-parameter Hill function for cumulative seed germination (El Kassaby, Y. et al., 2008, 54(2): 220-227), including, in particular, the rate of germination curve (“RoG curve”), fitted cumulative germination curve (“FCGC”), mean germination time (“MGT”), time at maximum germination (“TMGR”), time for 50% of seed to germinate (“t_{50Germ}”), time for x % (x=50) of the seed to germinate (“T_{50Total}”), and, the time interval during which between 10% and 90% of the seeds have germinated “(U₉₀-U₁₀)” for each PaleoGro treated and control plants. As can be seen in the graphs shown in FIG. 4C, seeds germinating in PaleoGro treated soil germinated faster, exhibiting an earlier MGT, an earlier TMGR, and an earlier t₅₀, when compared to the control. In particular, the MGT for the PaleoGro treated seeds was about 3.5 days vs the control about 4.5 days for the control, the TMGR was about 3.2 days for the PaleoGro treated seeds, vs about 4.2 days for the control, the t₅₀ was about 3.2 days for the PaleoGro treated seeds, vs about 4.3 days for the control, and the U₉₀-U₁₀ was about 1.3 days the PaleoGro treated seeds vs 2.8 days for the control. Furthermore, the rate RoG curve and FCGC curves indicate that a greater percentage of the PaleoGro treated seeds (about 100%) germinated when compared to the non-treated control (about 31%). Thus, in general, improved germination parameters are achieved when plants are treated with the PaleoGro formulation, compared to the untreated controls.

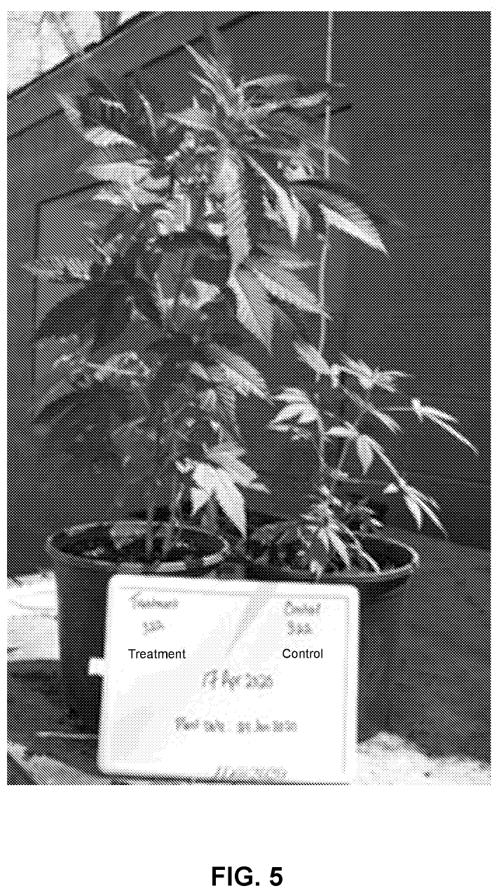

FIG. 5 shows a photograph of a representative hemp plant (variety 322) grown in soil treated with a plant growth formulation according to the present disclosure (plant on the left hand side) and a plant grown in soil treated with a control formulation (plant on the right hand side), taken 12 weeks from germination. Increased plant vigor and plant height can clearly be observed in the plant grown in soil treated with PaleoGro, compared to the plants grown in soil treated with a control formulation.

### Example 3

Plant Growth of Carrot, Spinach, Garlic, Potatoes, Beans, Onions, and Pumpkin Plants Treated with a Plant Growth Promoting Formulation

Individual cell suspensions of Bacillus pumilus (PBI0001), Bacillus megaterium (PBI0114), Kribbella flavida (PBI0106), and Micrococcus luteus (PBI0112) were prepared as described in Example 1, then diluted in 1% sucrose solution to a concentration of 5×10⁷ CFU/mL. Equal volumes of each of the four strains were mixed together to achieve a final concentration of each of the strains of 1×10⁷ CFU/mL. This bacterial mixture, referred to as PaleoGro-2, in this example was used as a formulation for spray irrigation application, as hereinafter described.

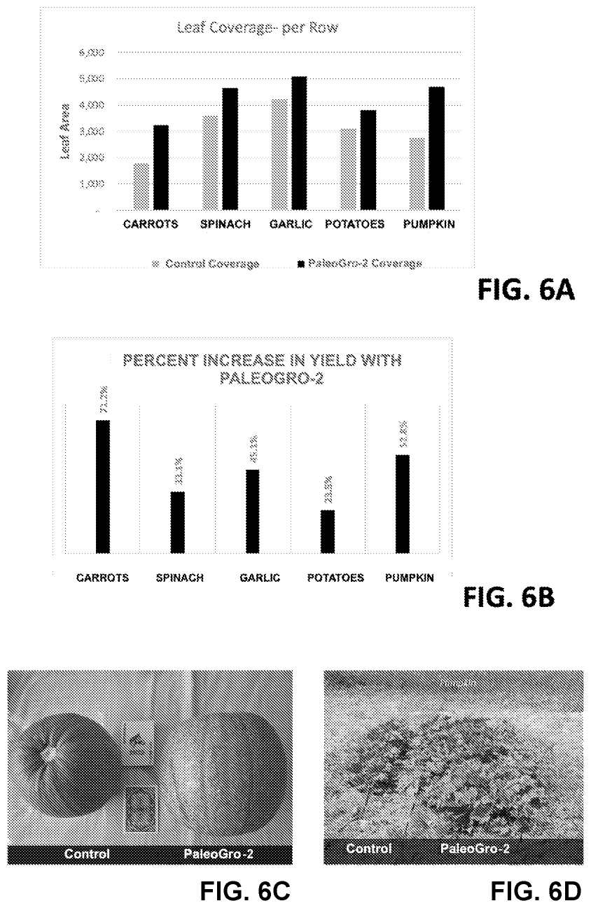

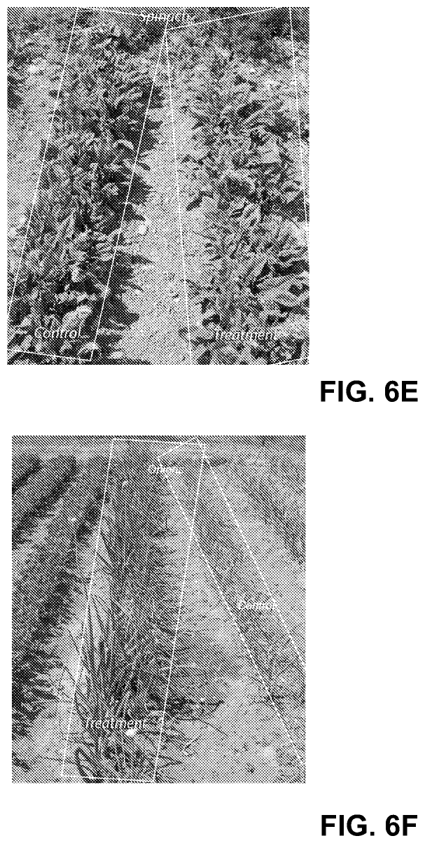

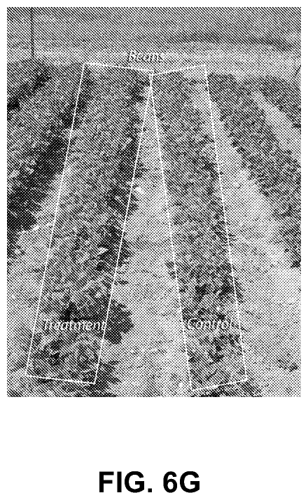

Small garden plots located in Capulin, Colo. (San Luis Valley) were planted with the following crop plants: carrot, spinach, garlic, potato, bean, lettuce, and pumpkin. Prior to planting, native soil plots were prepared and configured to allow for the growth of the crop plants in sixteen single rows, two side-by-side rows of each of the crop plants. Garlic was grown starting from cloves (planted in the fall of 2019), onions were grown starting from bulbs, and potatoes were grown starting from tubers (planted in the spring of 2020). All other plants were grown from seed (planted in the spring of 2020). Plants were grown until the crop was ready to be harvested. During the growth period, plants were tended for by regularly applying water to maintain appropriate soil moisture levels. No chemical fertilizers or pesticides were applied prior or during plant growth. The average temperature during the growth period was 72.5 F, precipitation was 0.9 inch, and the average humidity was 79.6%. PaleoGro-2 was mixed with water (100 ppm/gallon of water) and 5 gallons of the mixture was applied via drip irrigation to eight rows of each of the crop plants in the last week of June, 2020. The eight control rows at the same time received an equal volume of water without PaleoGro-2. Photographs of the eight control rows and eight rows treated with PaleoGro-2 were taken three weeks after PaleoGro-2 application, and used to determine leaf coverage by measuring leaf width (at the broadest leaf point) of 10 randomly selected leaves, and to determine yield by measuring row width. Results for carrots, spinach, garlic, potato, and pumpkin were graphed in bar graphs shown in FIG. 6A and FIG. 6B, respectively. Representative photographs of pumpkin plants and a pumpkin, obtained three weeks following growth treatment with PaleoGro (“PaleoGro-2”) and untreated control (“Control”) are shown in (FIG. 6C). Furthermore, representative photographs of spinach, onion and bean crops treated with PaleoGro-2 (“Treatment”) and untreated (“Control”) are shown in FIGS. 6E, 6F and 6G, respectively. Similar results were obtained for the other crop plants (not shown).

While the present disclosure has been described with reference to what are presently considered to be the preferred examples, it is to be understood that the disclosure is not limited to the disclosed examples. To the contrary, the disclosure is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety.

1-50. (canceled)

51. A method for promoting growth in a plant, the method comprising:
(a) contacting a plant with a plant growth promoting formulation comprising a growth promoting effective amount of a microbial preparation comprising a consortium of cultured microorganisms of the species Bacillus megaterium, Bacillus pumilus, Kribbella flavida, and Micrococcus luteus; and
(b) maintaining contact between the plant and the plant growth promoting formulation for a sufficient period of time for the consortium to microbially promote plant growth.

52. A method according to claim 51, wherein the microbial formulation additionally comprises cultured microorganisms of at least one of the genera selected from Acetobacter, Azospirillum, Azotobacter, Bacillus, Burkholderia, Frankia, Geobacillus, Microcoleus, Paenibacillus, Phormidium, Pseudomonas, Rhanella, Rhizobium, Serratia, Scytonema, Streptomyces, Synechococcus, and Tolypothrix.

53. A method according to claim 51, wherein the microbial formulation additionally comprises cultured microorganisms of the species Azotobacter vinelandii, Azotobacter beijerinckii, Azotobacter croococcum, or Azotobacter indicum.

54. A method according to claim 51, wherein the microbial formulation additionally comprises cultured microorganisms of at least one of the species selected from Geobacillus thermoglucosidasius, Microcoleus vaginatus, Paenibacillus xylenexedens, Phormidium ambiguum, Rhanella aquatica, Scytonema hyalinum, Scytonema javanicum, Streptomyces griseus, Streptomyces albogriseolus, Tolypothrix distorta.

55. A method according to claim 51, wherein the formulation further comprises a carrier.

56. A method according to claim 55, wherein the carrier is cellulose, hydroxyethyl cellulose, carboxymethyl cellulose, gypsum, vermiculite, attapulgite clay, diatomaceous earth, lignite powder, peat, alginate, blackstrap molasses, or humic acid.

57. A method according to claim 51, wherein the plant growth promoting formulation comprises from about 1×10\hat{ }2 CFU per ml to about 1×10\hat{ }8 CFU per ml or gram of each of the microorganisms.

58. A method according to claim 51, wherein the plant is (i) an agricultural crop plant selected from wheat (Triticum aestivum), oat (Avena sativa), corn (Zea mays), rice (Oryza sativa), soybean (Glycine max), oilseed rape (Brassica napus), Indian mustard (Brassica juncea), sunflower (Helianthus annuus), cotton (Gossypium hirsutum), peanut (Arachis hypogaea), tomato (Solanum lycopersicum), sorghum (Sorghum bicolor), a hay grass (rye grass (Lolium spp.), timothy (Phleum pretense), brome (Bromus spp.), fescue (Festuca spp.), Bermuda grass (Cynodon spp.), orchard grass (Dactylus spp.), alfalfa (Medicago sativa), clover (Trifolium spp.)), spinach (Spinacia oleracea), celery (Apium graveolens), onion (Allium cepa), asparagus (Asparagus officinalis), pumpkin (Cucurbita spp.), squash (Cucurbita spp.), zucchini (Cucurbita pepo), garlic (Allium sativum), carrot (Daucus carota subsp. sativus), potato (Solanum tuberosum), lettuce (Lactuca sativa), bean (Phaseolus vulgaris), strawberries (Fragaria spp.), blueberries (Vaccinium spp.), bananas (Musa spp.), and hemp (Cannabis sativa, Cannabis ruderalis, Cannabis indica); or (ii) a tree selected from a poplar (Populus deltoides), cottonwood (Populus section Ageiros), and a willow (Salix spp.); or (iii) a grass (Poaceae spp.) selected from Indian grass (Sorghastrum nutans), Agrostis spp., and annual bluegrass (Poa annua); or (iv) a flowering plant selected from Achillea millefolium (yarrow), Ageratum, Antirrhium majus (snapdragon), Begonia, Carophyllus (carnation), Chrysanthemum, Cineraria, Dianthus, Fuchsia, Consolida (Larkspur), Helianthus annuus (sunflower), Impatiens, Kalanchoe, Paeonia (peony), Pelargonium, Primula, Salvia, Scabiosa, Streptocarpus, Verbena bonariensis (tall verbena), and Zinnia.

59. A method according to claim 51, wherein the plant is grown on a plant growth substrate in need of phytoremedial treatment.

60. A method according to claim 59, wherein the phytoremedial treatment comprises a biodegradation process, a phyto-stabilization process, a phyto-accumulation process, a rhizofiltration process, a phyto-volatilization process, a phyto-degradation process, or a hydraulic control process.

61. A method according to claim 51, wherein the plant growth promoting formulation is applied to a plant leaf, root, seed, or stem of the plant, or to a plant growth substrate.

62. A method according to claim 61, wherein the plant growth promoting formulation is applied to the seed by applying the plant growth formulation to a plant growth substrate in which the seed is planted, wherein the seed germination rate exceeds the seed germination rate of seed not contacted with the plant growth formulation but otherwise grown under the same conditions.

63. A method according to claim 51, wherein the microorganisms in the consortium are viable and remain viable when the consortium is contacted with the plant or a plant growth substrate for the plant.

64. A method according to claim 51, wherein the formulation following contact with the plant, plant part or plant growth substrate modulates in planta, at least one of sarcosine oxidase enzyme activity, phosphonate metabolism, phosphoribosyl diphosphate (PRPP) synthase enzyme activity, aminocyclopropane-1-carboxylic acid (ACC) deaminase enzyme activity, tryptophan aminotransferase (TAA) enzyme activity, YUCCA flavin monooxygenase-like enzymes activity, phytohormone concentrations, siderophore activity, or glutathione (GSH) concentrations, to thereby promote plant growth.

65. A plant growth promoting formulation comprising:
a growth promoting effective amount of a microbial preparation comprising a consortium of cultured microorganisms of the species Bacillus megaterium, Bacillus pumilus, Kribbella flavida, and Micrococcus luteus.

66. A plant growth promoting formulation according to claim 65, wherein the microbial formulation additionally comprises cultured microorganisms of at least one of the genera selected from Acetobacter, Azospirillum, Azotobacter, Bacillus, Burkholderia, Frankia, Geobacillus, Microcoleus, Paenibacillus, Phormidium, Pseudomonas, Rhanella, Rhizobium, Serratia, Scytonema, Streptomyces, Synechococcus, and Tolypothrix.

67. A plant growth promoting formulation according to claim 65, wherein the microbial formulation additionally comprises cultured microorganisms of the species Azotobacter vinelandii, Azotobacter beijerinckii, Azotobacter croococcum, or Azotobacter indicum.

68. A plant growth promoting formulation according to claim 65, wherein the microbial formulation additionally comprises a cultured microorganism of one of the species selected from Geobacillus thermoglucosidasius, Microcoleus vaginatus, Paenibacillus xylenexedens, Phormidium ambiguum, Rhanella aquatica, Scytonema hyalinum, Scytonema javanicum, Streptomyces griseus, Streptomyces albogriseolus, Tolypothrix distorta.

69. A plant growth promoting formulation according to claim 65, wherein the formulation further comprises a carrier.

70. A plant growth promoting formulation according to claim 65, wherein the plant growth promoting formulation comprises from about 1×10\hat{ }2 CFU per ml to about 1×10\hat{ }8 CFU per ml or gram of each of the microorganisms.
